(19) United States
(12) Patent Application Publication
(10) Pub. No.: US 2011/0040722 A1
(43) Pub. Date: Feb. 17, 2011

(54) PREDICATE SELECTION IN EVENT FILTERING

(75) Inventors: Catherine Moxey, Hursley Park (GB); Anthony Papageorgiou, Hursley Park (GB)

Correspondence Address: IBM Corp. (AUS/RCR);c/o Rolnik Law Firm, P.C., 24 N. Main St., Kingwood, TX, 77339, US

(73) Assignee: INTERNATIONAL BUSINESS MACHINES CORPORATION, Armonk, NY (US)

(21) Appl. No.: 12/840,984

(22) Filed: Jul. 21, 2010

(30) Foreign Application Priority Data
Aug. 17, 2009 (GB) 09167982.9

(51) Int. Cl. G06F 17/00

(52) U.S. Cl. 706/56

(57) ABSTRACT

An apparatus, method and computer program for evaluating an event in a data processing system, wherein the event comprises a plurality of predicates, the apparatus comprising: a receive component operable for receiving the event; an analyze component, operable for analyzing a plurality of first relationships between the plurality of predicates and a plurality of first values; an order component, operable for ordering the plurality of predicates; an evaluate component, responsive to the order component identifying that one of the plurality of predicates is a primary predicate, operable for evaluating the event for the primary predicate and for determining a result, wherein the result indicates whether the event is true or false for the primary predicate; and an update component, responsive to the evaluate component evaluating the event for the primary predicate, operable for updating the plurality of first values.

### FOREIGN APPLICATION PRIORITY DATA

This application claims benefit of priority of Foreign Patent Application No. GB 09167982.9, filed in the United Kingdom on Aug. 17, 2009, which is herein incorporated by reference.

### BACKGROUND OF THE INVENTION

1. Field of the Invention

The present invention relates generally to business event filtering. In particular, the invention relates to an apparatus, method, and computer program for selecting the order in which predicates may be selected in business event filtering.

2. Description of the Related Art

In a data processing system a ‘business event’ is an identifiable occurrence that has some significance. An example of a business event is the share price of a company.

Event Processing is the task of processing multiple business events to identify those business events that are of interest in particular circumstances. Event processing software may monitor business events and look out for certain patterns that may be of interest. Once identified, an event of interest may trigger a further action of the data processing system. For example, if a share price reaches a certain amount, the data processing system may trigger a sale of the share.

Processing of business events, to determine whether an occurrence is an event that is of interest, may be based on evaluating a plurality of predicates that define the specific event of interest. For example, a set of predicates may indicate that the event is of interest if it occurs when a particular command is executed; in a particular program; at a particular time of day; or, where a value exceeds a particular amount. The evaluation of such a complicated set of predicates may carry a performance penalty. To address this, a preferred order of evaluation may be identified for a type of event, being the check that it is believed will most quickly narrow down the selection. However, static identification of the evaluation order requires assumptions about the pattern of occurrences of the unfiltered event, which might not be correct.

Therefore, there is a need in the art to address the aforementioned problem.

### SUMMARY OF THE INVENTION

Viewed from a first aspect, the present invention provides a computer management apparatus for evaluating an event in a data processing system, wherein the event comprises a plurality of predicates, the apparatus comprising: a receive component operable for receiving the event; an analyze component, in response to the receive component receiving the event, operable for analyzing a plurality of first relationships between the plurality of predicates and a plurality of first values; and an order component, operable for ordering the plurality of predicates.

Advantageously, the present invention provides for the early selection of a primary predicate of an event that will provide a false result, thereby eliminating the need to evaluate an event against the other predicates of the event.

Preferably, the present invention provides an apparatus, wherein the apparatus further comprises an evaluate component, responsive to the order component identifying that one of the plurality of predicates is a primary predicate, operable for evaluating the event for the primary predicate and for determining a result, wherein the result indicates whether the event is true or false for the primary predicate.

Preferably, the present invention provides an apparatus, wherein the apparatus further comprises an update component, responsive to the evaluate component evaluating the event for the primary predicate, operable for updating the plurality of first values.

Advantageously, the present invention provides for an event specification of an event type to be updated after each evaluation, so that the subsequent choice of primary predicate is based on the most recent information. The event specification may be used during evaluations of an event against a set of predicates, or for the evaluations of a plurality of events of the same type.

Preferably, the present invention provides an apparatus, wherein the apparatus further comprises a discard component, responsive to the evaluate component determining a false result, operable for discarding the event.

Advantageously, the present invention provides for the event to be discarded as soon as a false result has been identified. Thereby further evaluations are not necessary for the event.

Preferably, the present invention provides an apparatus, wherein the apparatus further comprises a send component, responsive to the evaluate component evaluating the event for the primary predicate, operable for sending a message. Advantageously, the present invention provides for the apparatus to send a message as a result of the evaluation of a predicate, for example; to emit the event as being of interest; or, to send a message in conjunction with the discard of the event.

Preferably, the present invention provides an apparatus, wherein a first value relating to a predicate comprises the plurality of false results of the predicate, and wherein the ordering component is operable for ordering the plurality of predicates according to the plurality of first values.

Advantageously, the present invention provides for ordering to be performed on a plurality of algorithms, for example: on a previous number of false results received for the predicate; or, on a minimum average evaluation time for a given order of predicates.

Viewed from a second aspect, preferably, the present invention provides a method for evaluating an event in a data processing system, wherein the event comprises a plurality of predicates, the method comprising the steps of: receiving the event; in response to receiving the event, analyzing a plurality of first relationships between the plurality of predicates and a plurality of first values; and ordering the plurality of predicates.

Preferably, the present invention provides a method, the method further comprising the steps of, in response to identifying that one of the plurality of predicates is a primary predicate, evaluating the event for the primary predicate and determining a result, wherein the result indicates whether the event is true or false for the primary predicate.

Preferably, the present invention provides a method, the method further comprising the step of, in response to evaluating the event for the primary predicate, updating the plurality of first values.

Preferably, the present invention provides a method, the method further comprising the step of, in response to determining a false result, discarding the event.

Preferably, the present invention provides a method, the method further comprising the step of, in response to evaluating the event for the primary predicate, sending a message.

Preferably, the present invention provides a method, wherein a first value relating to a predicate comprises the plurality of false results of the predicate, the method further comprising the step of ordering the plurality of predicates according to the plurality of first values.

Viewed from a third aspect, the present invention provides a computer program comprising computer code to, when loaded into a computer system and executed thereon, cause the computer system to perform all of the steps of the invention.

### BRIEF DESCRIPTION OF THE DRAWINGS

The present invention will now be described, by way of example only, with reference to preferred embodiments, as illustrated in the following figures:

FIG. 1 is a block diagram depicting a data processing system, in accordance with the prior art, and in which a preferred embodiment of the present invention may be implemented;

FIG. 2 is a high-level exemplary schematic flow diagram depicting typical event evaluation, according to the prior art;

FIG. 3 is a high-level exemplary schematic flow diagram depicting typical operation method steps performed for selecting the order in which predicates may be evaluated, according to a preferred embodiment of the present invention;

FIG. 4 is an exemplary block diagram depicting a computer management apparatus, according to a preferred embodiment of the present invention;

FIG. 5 is an exemplary event specification depicting information in a data processing system, according to a preferred embodiment of the present invention; and

FIG. 6 is another exemplary event specification depicting information used in a store of the data processing system, in accordance with a preferred embodiment of the present invention.

### DETAILED DESCRIPTION OF THE PREFERRED EMBODIMENT

In a preferred embodiment of the invention, the order of evaluation of the predicates is heuristically tuned to optimize the time taken to evaluate the set, by discovering the events that are not a match as quickly as possible.

This invention is based on storing historical information about the order of evaluation of the predicates for a particular event type, and about how quickly a false predicate was found, enabling an instance of the event type to be discarded and the remainder of the predicate evaluations to be skipped. This is used in combination with an algorithm for ordering the predicate evaluations. The invention introduces the concept of a ‘primary predicate’ that is initially identified as the most efficiently evaluated predicate for all filtering expressions relating to a particular type of event. The learning in this invention is to determine heuristically, based on runtime experience, whether a different predicate should be identified as the primary predicate. This learning may be applied not only to a specific event where the experience is being collected, but also to other events of that type.

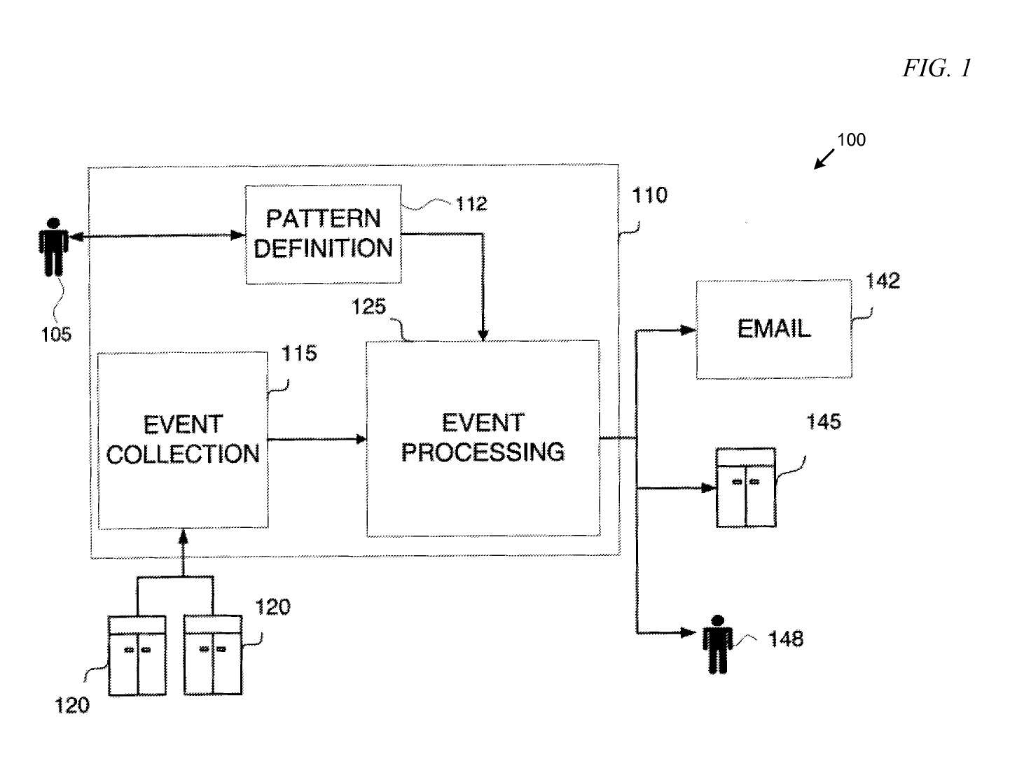

FIG. 1 is a block diagram depicting a data processing system 100, in accordance with the prior art, and in which a preferred embodiment of the present invention may be implemented. A user 105 defines patterns by defining events of interest in a definition component 112. An event processing component 125 is operable on a server application 110 operable on a server (not depicted). Events are received from activities within the server and other parts of the data processing system, for example from servers 120 by the collect component 115. The events are passed to the event processing component 125.

The event processing component 125 monitors events to compare the event with the defined patterns, by evaluating the event against a set of predicates. The event does not match the pattern, if an evaluation of the event produces at least one ‘false predicate’. If the event does not match the pattern, the event is discarded. In contrast, the event matches the pattern, if an evaluation of the event against all predicates produces only true predicates. If the event matches the pattern, an action may be triggered, or the event may be passed on for further event processing. Examples of actions are: sending an email in an email subsystem 142; interaction with other components 145 of the data processing system 100; or, a human interaction subsystem 148. An example of a human interaction subsystem 148 is one whether a human operator needs to react to an error condition. For the avoidance of doubt, a ‘false predicate’ as used herein throughout the description and claims is to be construed as meaning that the evaluation of the event under consideration produces a false result.

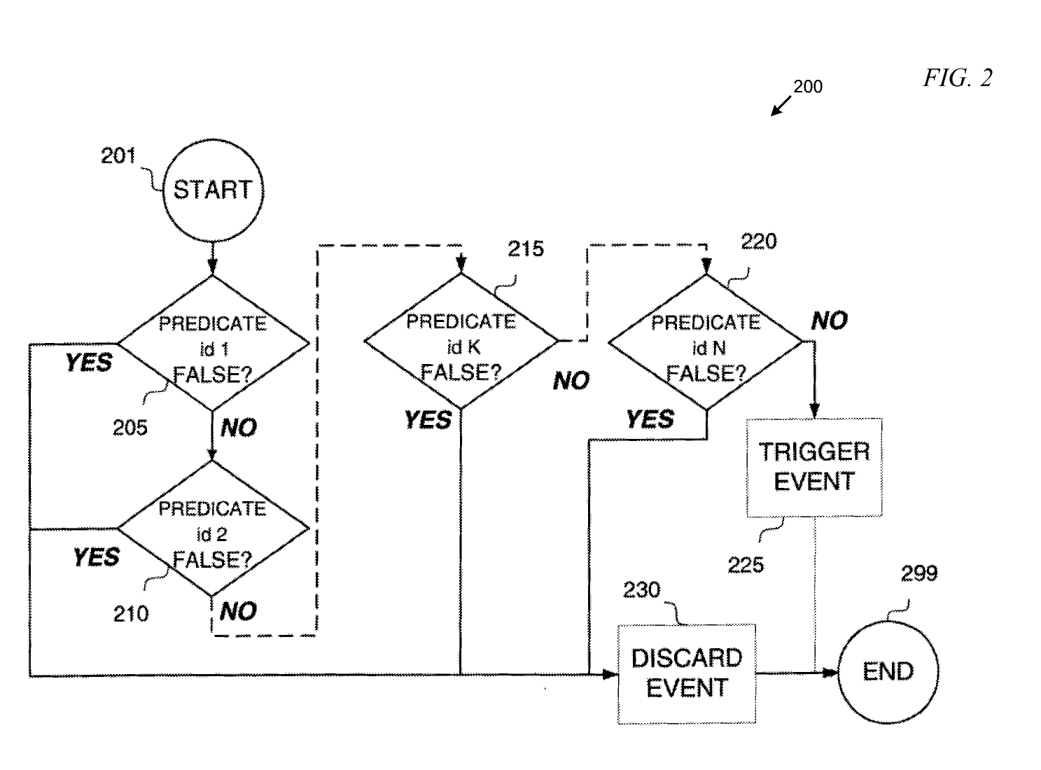

FIG. 2 is a high-level exemplary schematic flow diagram 200 depicting typical event evaluation for a set of N predicates in order, ‘id 1’, ‘id 2’, ‘id K’, ‘id N’, according to the prior art. The method starts at step 201. At steps 205, 210, 215, and 220, the event is evaluated to determine whether the event is false for predicates ‘id 1’, ‘id 2’, ‘id K’, ‘id N’ respectively. If any of the events are false, at step 230, the event is discarded. However, if the event is evaluated for ‘id 1’, ‘id 2’, ‘id K’, ‘id N−1’ as true, at steps 210, 215, and 220 respectively, the event is evaluated for the subsequent predicate. At step 220, the event is evaluated for ‘id N’. If ‘id N’ is true, at step 225, as all predicates have been evaluated as being true, the event action is triggered. The flow ends at step 299.

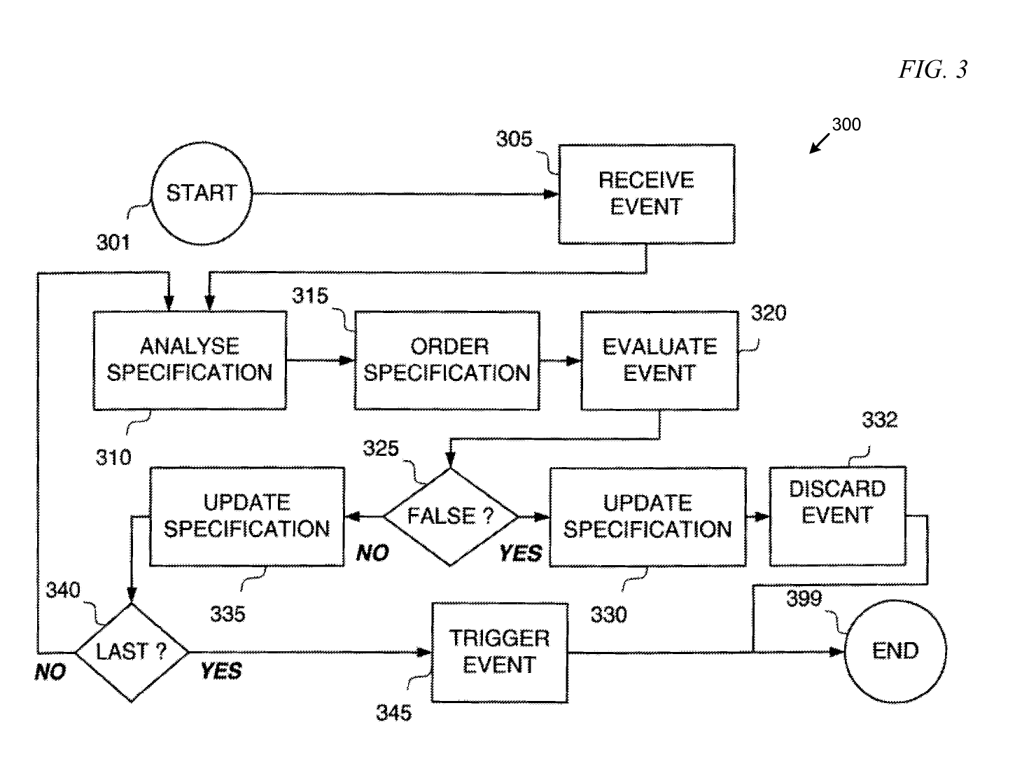

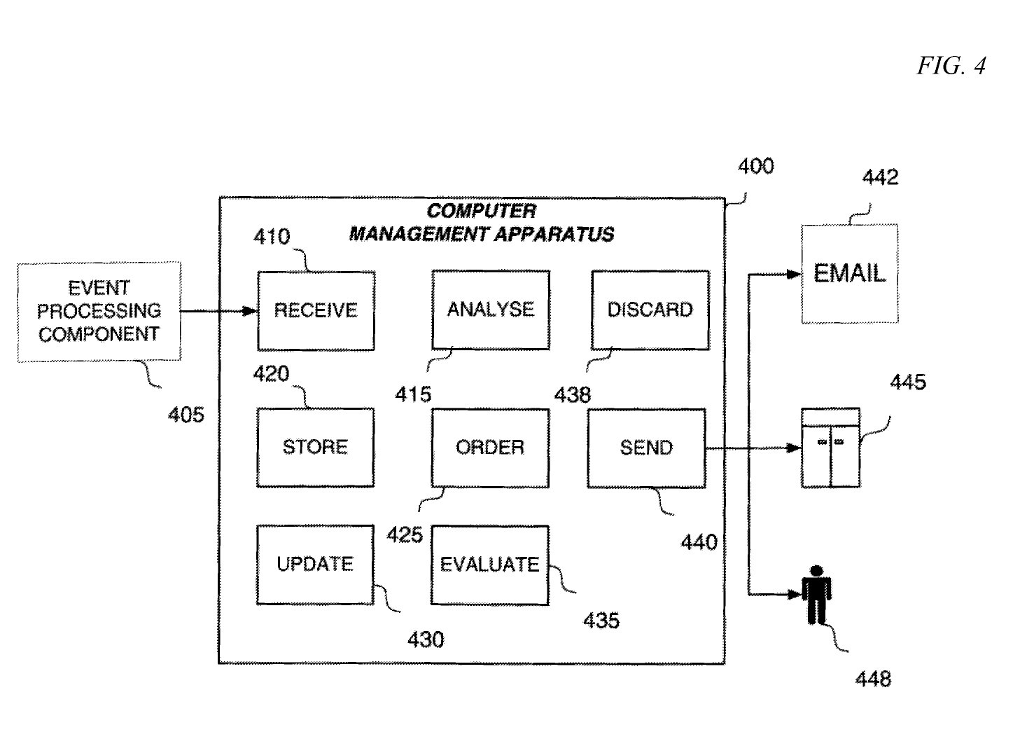

FIG. 3, which should be read in conjunction with FIGS. 4, 5, and 6, is a high-level exemplary schematic flow diagram 300 depicting typical operation method steps performed for selecting the order in which predicates may be evaluated in business event filtering, in which a preferred embodiment of the present invention may be implemented.

FIG. 4, is an exemplary block diagram depicting a computer management apparatus 400 in which a preferred embodiment of the present invention may be implemented.

A computer management apparatus 400 is operable with an event processing component 125. As discarding an event that does not match a specific pattern comprises only one false predicate, performance of the data processing system 100 may be improved if the false predicate is identified early in the sequence of evaluations, as no further evaluations on the event are necessary.

In a preferred embodiment of the invention, a primary predicate is chosen to evaluate the event against. A primary predicate is the most likely predicate for an event that will be evaluated as false, so that the event may be discarded and the remainder of the predicate evaluations to be skipped. The advantage of evaluating the event for the primary predicate first is to complete the overall evaluation in a minimum time, and with the minimum number of computing resources. If a primary predicate does not prove to be false, another primary predicate is chosen for the event to be evaluated against.

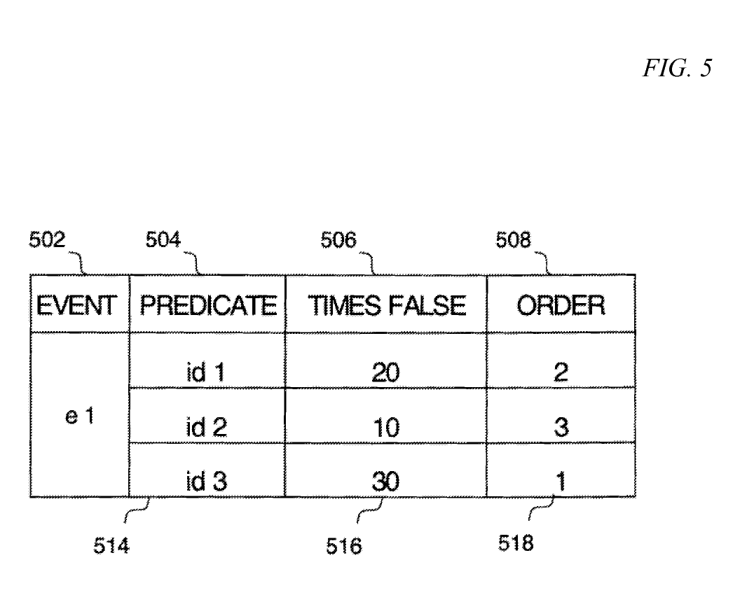

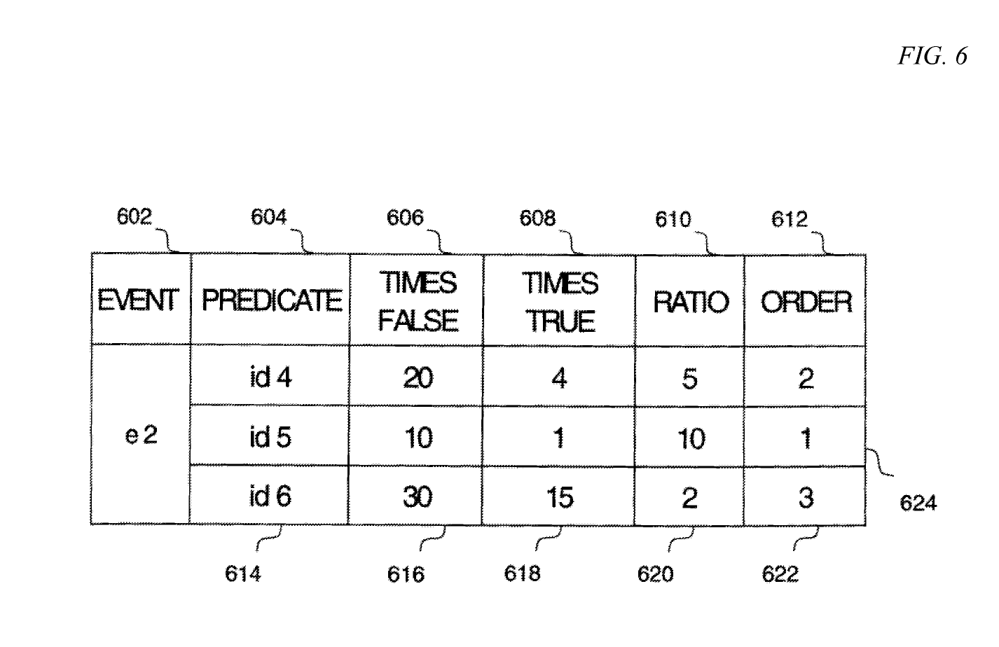

The method starts at step 301, when an event is received by the receive component 410 of the computer management apparatus 400 from an event processing component 405. The event comprises a set of predicates. At step 310, the analyze component 415 analyzes an event specification 500 and 600 in a store 420 that comprises information about the event type or the individual event. The information comprises, for example, relationships between the constituent predicates of the event type, and a set of values. The set of values represent historical information about the order of evaluation of the predicates for a particular event type. For example, a value for a predicate may comprise the number of times that an event of the event type has been evaluated as being false for the predicate. Examples of an event specification 500 and 600 are depicted in FIGS. 5 and 6 described below.

At step 315, an order component 425 orders the predicates based on the relating values in the store 420. The algorithm for ordering the predicate evaluation may be amended based on historical information. The algorithm determines an initial evaluation based on hard coded knowledge about the nature of the event being processed and a primary predicate typically associated with that event. As potential events occur which are subject to the predicate checking, the average number of checks required to determine that the event does not match is stored as part of the event specification, and the algorithm is heuristically amended to use a different predicate as the primary predicate, until the average is minimized. As a result of the ordering, the order component 435 identifies a primary predicate.

At step 320, an evaluate component 435, evaluates the event specification for the primary predicate. The evaluate component 435 also determines, at step 325, whether the event is false for the primary predicate. If the event is false for the primary predicate, at step 330, the update component 430 updates the event specification 500 and 600 with information relating to the primary predicate. The information relates to the false result of the predicate. The updated information is used in subsequent event evaluations. At step 332, the discard component 438 discards the event as the event was evaluated as false for the predicate. However, if the event was true for the primary predicate, at step 340, the update component 430 updates the event specification 500 and 600 with information relating to the primary predicate. The information relates to the true result of the predicate. At step 340, the update component 430 determines whether there are any more predicates for the event to be evaluated against. If there are more predicates to evaluate, control passes to step 310 to analyze the store 420 with the updated information from step 335. However, if there are no more predicates for the event to be evaluated against, at step 345, the event triggers, because all of the predicates associated with the event are true. In a preferred embodiment, when the event triggers, the send component 440 sends an action message to an email subsystem 142, 442, other system components 145 and 445 in the data processing system 100, or to a human interaction subsystem 148 and 448. In an alternative embodiment, when an event is discarded, the send component 440 also sends a message to a system component 145 and 445. The discard message comprises details about the discarded event.

FIG. 3 is set forth as logical flow chart diagrams. As such, the depicted order and labeled steps are indicative of one embodiment of the presented method. Other steps and methods may be conceived that are equivalent in function, logic, or effect of one or more steps or portions thereof, of the illustrated method. Additionally the format and symbols employed are provided to explain the logical steps of the method and are understood not to limit the scope of the method.

FIG. 5 is an exemplary event specification 500 depicting information used in a store 420 of the data processing system 10, in which a preferred embodiment of the present invention may be implemented. The event specification 500 depicts relationships between predicates, and related information 506 and 512 for an event type ‘e 1’. The event specification 500 comprises a plurality of columns 502, 504, 506, and 512. The event type column comprises an identification number ‘e 1’ for the event type under consideration in the event specification 500. The predicate column 504, comprises the identification numbers of the predicates applicable to the event type ‘e 1’. One predicate ‘id 3’ is depicted in cell 514. The times false column 504, comprises the number of times that the event has been evaluated as being false for each predicate. For example, the calculation of number of times may be the number that the event was evaluated as false for a predicate in a previous defined time period. The order column 512 comprises an ordering of the predicates based on the values found in the times false column 506. To illustrate the use of the event specification 500, predicate ‘id 3’ is depicted as having been evaluated as false 30 times in cell 516. In this example, the order of the predicate evaluation is based on the number of times that the event type has been evaluated as false for a predicate. The highest order corresponds to the highest number of true evaluations, indicated by the entry ‘1’ in cell 518. Therefore, predicate ‘id 3’ is identified as the primary predicate.

FIG. 6 is another exemplary event specification 600 depicting information used in a store of the data processing system 10, in which a preferred embodiment of the present invention may be implemented. The event specification 600 depicts relationships between predicates, and related information for an event type ‘e 2’. The event specification 600 comprises a plurality of columns 602, 604, 606, 608, 610, and 612. The event column comprises an identification number ‘e 2’ for the event type under consideration in the table. The predicate column 604 comprises the identification numbers of the predicates applicable to the event type ‘e 2’. One predicate ‘id 7’ is depicted in cell 614. The times false column 604, comprises the number of times that the event type has been evaluated as being false for each predicate. The times true column 608 comprises the number of times that the event type has been evaluated as being true for that predicate. The ratio column 608 comprises information on the ratio between times false and times true evaluations for each predicate. The order column 612 comprises an ordering of the predicates based on the values found in the ratio column 610. To illustrate the use of the event specification 600, predicate ‘id 6’ is depicted as having been evaluated as true 30 times in cell 616, and as true 15 times in cell 618. The ratio is depicted as 2 in cell 620. In this example, the order of the predicate evaluation is based on the ratio, and is indicated by the entry ‘3’ in cell 622. The primary predicate is chosen as ‘id 2’, as depicted by the entry in cell 624.

The tables of FIGS. 5 and 6 are two examples of how the primary predicate may be chosen. However, it will be appreciated by the person skilled in the art, that the order of evaluations may be based on other criteria. As potential events occur which are subject to the predicate checking, the average number of checks required to determine that the event does not match is stored as part of the event specification, and the algorithm is heuristically amended to use a different predicate as the primary predicate, until the average is minimized.

In an alternative embodiment, the time taken to complete evaluation of the event is measured with different orderings of evaluation, in order to determine an optimum ordering based on average time to produce a false predicate.

It will be clear to one of ordinary skill in the art that all or part of the method of the preferred embodiments of the present invention may suitably and usefully be embodied in a logic apparatus, or a plurality of logic apparatus, comprising logic elements arranged to perform the steps of the method and that such logic elements may comprise hardware components, firmware components or a combination thereof.

It will be appreciated that the method and arrangement described above may also suitably be performed fully or partially in software running on one or more processors (not depicted in the figures), and that the software may be provided in the form of one or more computer program elements carried on any suitable data-carrier (also not depicted in the figures) such as a magnetic or optical disk or the like.

In the preferred embodiment of the invention, all customer activities are converted into business events, and the method used to analyze which business events are of interest. In an alternative embodiment of the invention, the set of customer processing steps are analyzed, and any customer processing steps of interest are converted into a business event for further processing.

For the avoidance of doubt, the term ‘comprising’, as used herein throughout the description and claims is not to be construed as meaning ‘consisting only of’.

1-13. (canceled)

14. A computer management apparatus for evaluating an event in a data processing system, wherein the event comprises a plurality of predicates, the computer management apparatus comprising:
a receive component operable for receiving the event;
an analyze component, in response to the receive component receiving the event, operable for analyzing a plurality of first relationships between the plurality of predicates and a plurality of first values; and
an order component, operable for ordering the plurality of predicates.

15. The computer management apparatus of claim 14, wherein the computer management apparatus further comprises an evaluate component, responsive to the order component identifying that one of the plurality of predicates is a primary predicate, operable for evaluating the event for the primary predicate and for determining a result, wherein the result indicates whether the event is true or false for the primary predicate.

16. The computer management apparatus of claim 15, wherein the computer management apparatus further comprises an update component, responsive to the evaluate component evaluating the event for the primary predicate, operable for updating the plurality of first values.

17. The computer management apparatus of claim 15, wherein the computer management apparatus further comprises a discard component, responsive to the evaluate component determining a false result, operable for discarding the event.

18. The computer management apparatus of claim 15, wherein the computer management apparatus further comprises a send component, responsive to the evaluate component evaluating the event for the primary predicate, operable for sending a message.

19. The computer management apparatus of claim 15, wherein a first value relating to a predicate comprises a plurality of false results of the predicate, and wherein the ordering component is operable for ordering the plurality of predicates according to the plurality of first values.

20. A computer implemented method for evaluating an event in a data processing system, wherein the event comprises a plurality of predicates, the computer implemented method comprising:
receiving the event;
in response to receiving the event, analyzing a plurality of first relationships between the plurality of predicates and a plurality of first values; and
ordering the plurality of predicates.

21. The computer implemented method of claim 20, the computer implemented method further comprising: in response to identifying that one of the plurality of predicates is a primary predicate, evaluating the event for the primary predicate and determining a result, wherein the result indicates whether the event is true or false for the primary predicate.

22. The computer implemented method of claim 21, the computer implemented method further comprising: in response to evaluating the event for the primary predicate, updating the plurality of first values.

23. The computer implemented method of claim 21, the computer implemented method further comprising: in response to determining a false result, discarding the event.

24. The computer implemented method of claim 21, the computer implemented method further comprising: in response to evaluating the event for the primary predicate, sending a message.

25. The computer implemented method of claim 21, wherein a first value relating to a predicate comprises a plurality of false results of the predicate, the computer implemented method further comprising: ordering the plurality of predicates according to the plurality of first values.

26. A computer program product for evaluating an event in a data processing system, wherein the event comprises a plurality of predicates, the computer program product comprising:
a computer readable storage medium having computer readable program code embodied therewith, the computer readable program code comprising:
computer readable program code configured to receive the event;
computer readable program code configured to in response to receiving the event,
analyze a plurality of first relationships between the plurality of predicates and a plurality of first values; and
computer readable program code configured to order the plurality of predicates.
